(19) United States
(12) Patent Application Publication
(10) Pub. No.: US 2008/0033838 A1
(43) Pub. Date: Feb. 7, 2008

(54) Systems and methods for purchasing personalized products

(75) Inventor: Chih-Wei Wang, Taipei Hsien (TW)

Correspondence Address: BIRCH STEWART KOLASCH & BIRCH, PO BOX 747, FALLS CHURCH, VA, 22040-0747, US

(73) Assignee: GIGA-BYTE TECHNOLOGY CO., LTD.

(21) Appl. No.: 11/826,341

(22) Filed: Jul. 13, 2007

(30) Foreign Application Priority Data
Aug. 1, 2006 (TW) 95128127

(51) Int. Cl. G06Q 30/00; G06F 17/30

(52) U.S. Cl. 705/27

(57) ABSTRACT

Systems for purchasing personalized products are provided. An embodiment of a system for purchasing personalized products includes a client node and a supplier node. The supplier node provides a product packet comprising a product and multiple components belonging to the product, and transmits the product packet to the client node. The client node comprises a client interface displaying product packet information, and facilitating selection of a portion of the components belonging to the product by a user to generate assembly information, and generates an order packet according to the user provided assembly information. The supplier node receives the order packet from the client node.

### BACKGROUND

The invention relates to order management, and more particularly, to systems and methods for purchasing personalized products.

With the spread of network technology, users have come to know various network applications. Network technology has dramatically changed conventional purchasing. Users now want to buy products over networks rather. Furthermore, with globalization, the distances between buyers and sellers have increased. Transactions across cities, provinces, countries, and continents are also increasing. Issues concerning users are efficiency and convenience in purchasing products from various places. Thus, electronic purchasing systems have been introduced. Due to the advantages of efficiency and convenience of network shopping, network bidding, network purchasing, and network bookstore systems have also emerged. Buyers can shop for products by browsing Web pages, and order the desired products via a network shopping system, thus completing a network transaction.

Current network purchasing systems, however, only provide packaged products to customers. Customers can select, buy and have packaged products delivered. Although the network purchasing system satisfies the requirements of distant orders, conventional network purchasing systems are not capable of meeting customized product requirements because the content/specification of packaged products can not be changed. Some users may focus on product price, while others may focus on product performance. Certain customer groups, such as young people with high expendable income regular online consumption patterns, prefer to purchase products having personalized parts for fulfilling their personal tastes or needs. They do not want to buy the same products that everybody else buys. Conventional electronic purchasing systems do not typically provide means for personalizing electronic products. Systems and methods for purchasing personalized products are desirable.

### SUMMARY

Systems for purchasing personalized products are provided. An exemplary embodiment of a system for purchasing personalized products comprises a client node and a supplier node. The supplier node provides a product packet comprising product and multiple component information. The product packet is transmitted to the client node. The client node comprises a client interface displaying product packet information, means for selecting components belonging to the product for generating assembly information. An order packet can then be generated according to the user provided assembly information. The supplier node receives the order packet from the client node.

Methods for purchasing personalized products are provided. An embodiment of a method for purchasing personalized products comprises following steps. A supplier node, according to a product and multiple associated component information, generates a product packet. The product packet is transmitted to a client node by the supplier node. The client node generates an order packet reflecting user selected product components. The order packet is transmitted to the supplier node by the client node. The supplier node then displays the received order packet information, thus, a manufacture can deliver a customized product to a user according to the order packet information.

### BRIEF DESCRIPTION OF THE DRAWINGS

The invention can be more fully understood by reading the subsequent detailed description and examples with references made to the accompanying drawings, wherein:

FIG. 1 is a diagram of a hardware environment applicable to an embodiment of a personal computer;

FIG. 2 is a diagram of the network architecture of a first embodiment of a system for purchasing personalized electronic products;

FIG. 3 is a flowchart illustrating a first embodiment of a method for purchasing personalized electronic products;

FIG. 4 is a message sequence diagram of a first embodiment for purchasing personalized electronic products;

FIG. 5 is a diagram of the network architecture of a second embodiment of a system for purchasing personalized electronic products;

FIGS. 6A and 6B are flowcharts illustrating a second embodiment of a method for purchasing personalized electronic products;

FIG. 7 is a message sequence diagram of a second embodiment for purchasing personalized electronic products.

### DETAILED DESCRIPTION

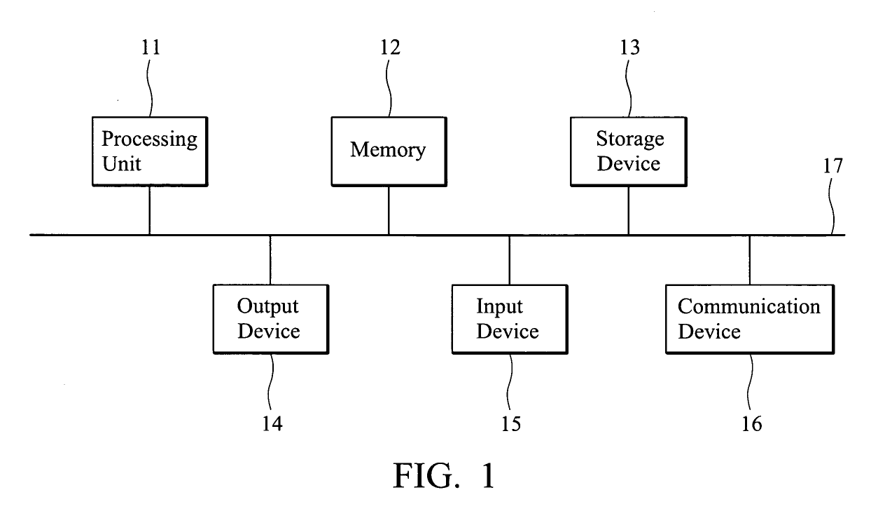

FIG. 1 is a diagram of a hardware environment applicable to an embodiment of a personal computer, comprising a processing unit 11, memory 12, a storage device 13, an output device 14, an input device 15 and a communication device 16. Moreover, those skilled in the art will recognize that some embodiments may be practiced with other computer system configurations, including multiprocessor-based, microprocessor-based or programmable consumer electronics, network PCs, minicomputers, mainframe computers, and the like. The programmable consumer electronics may be mobile stations, projectors, displayers, mp3 players, digital video recorders or the like. The processing unit 11 is connected by buses 17 to the memory 12, storage device 13, output device 14, input device 15 and communication device 16. There may be one or more processing units 11, such that the processor of the computer comprises a single central processing unit (CPU), a microprocessing unit (MPU) or multiple processing units, commonly referred to as a parallel processing environment. The memory 12 is preferably a random access memory (RAM), but may also include read-only memory (ROM) or flash ROM. The memory 12 preferably stores program modules executed by the processing unit 11 to perform methods for purchasing personalized products. Generally, program modules include routines, programs, objects, components, or others, that perform particular tasks or implement particular abstract data types. Some embodiments may also be practiced in distributed computing environments where tasks are performed by remote processing devices linked through a communication network. In a distributed computing environment, program modules may be located in both local and remote memory storage devices based on various remote access architectures such as DCOM, CORBA, Web objects, Web Services or similar.

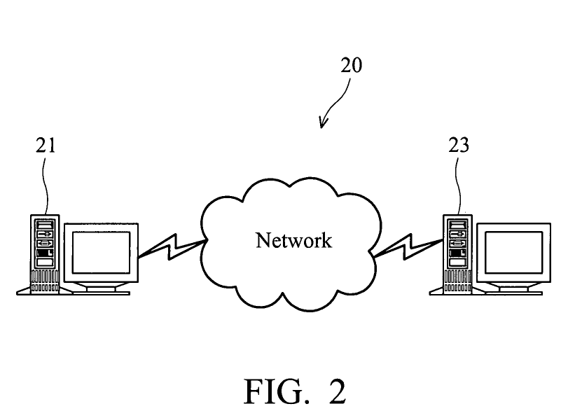

FIG. 2 is a diagram of the network architecture of a first embodiment of a system for purchasing personalized electronic products 20, preferably comprising personal computers 21 and 23. The personal computers may be practiced in the hardware environment illustrated by FIG. 1. The personal computers 21 and 23 may be connected for operating in a wired, wireless or mixed network. Those skilled in the art will recognize that the personal computers 21 and 23 may be connected in different types of networking environments, and with communication conducted via various types of transmission devices such as routers, gateways, access points, base station systems or others. The personal computer 21 represents a supplier node, and the personal computer 23 represents a client node.

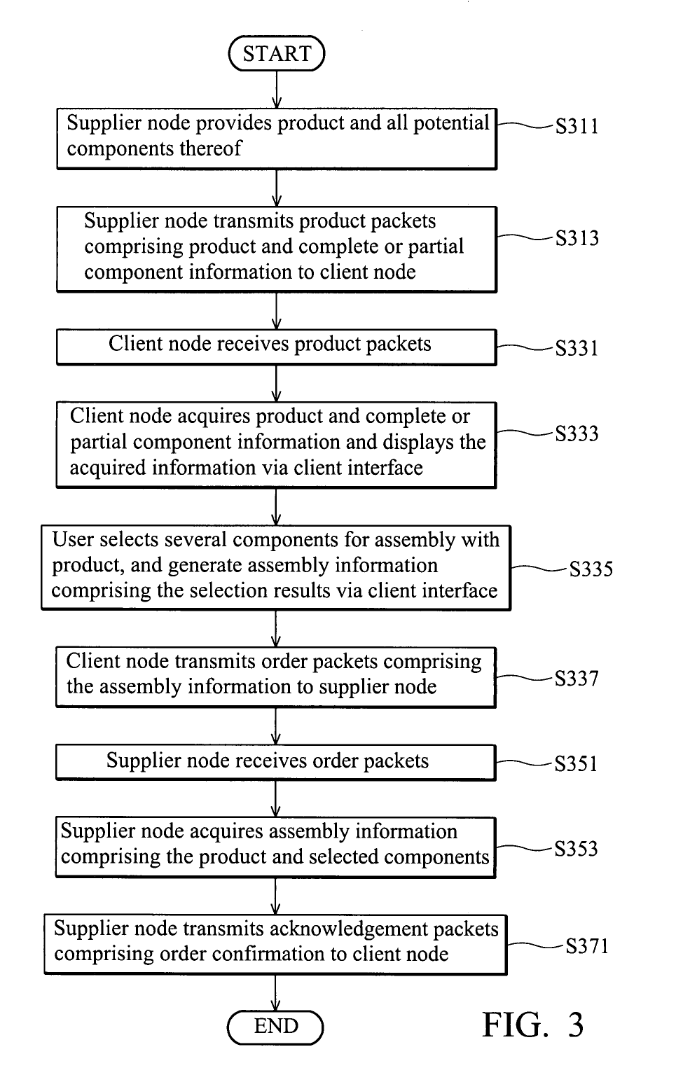

FIG. 3 is a flowchart illustrating a first embodiment of a method for purchasing personalized electronic products. In step S311, a product and all potential components thereof (including parts and accessories) are provided by the supplier node 21. For example, all the optical drives with which a notebook may potentially be equipped may include CD-ROM, CD-RW, DVD-ROM, DVD-RW, and similar, and all potential memories may include 128 M, 256 M, 512 M, 1 G, 2 G memories, and similar. In step S313, the supplier node 21 transmits product packets comprising the product and complete or partial component information to the client node 23. In step S331, the product packets are received by the client node 23. In step S333, the product and complete or partial component information is acquired by the client node 23, and the acquired information is displayed via a client interface (e.g. a Web page). In step S335, several components, such as a DVD-RW, 2 G memories, a mouse and others, are selected for assembly with the product, and assembly information comprising the selection results are generated via the client interface by the client node 23. In step S337, order packets comprising the assembly information are transmitted to the supplier node 21 by the client node 23. In step S351, order packets are received by the supplier node 21. In step S353, the supplier node 21 acquires assembly information comprising the product and selected components. The supplier node 21 may comprise a supplier interface for displaying the product and selected components, enabling the operators to deliver the product containing the selected components to the customer. In step S371, acknowledgement packets comprising order confirmation are transmitted to the client node 23 by the supplier node 21. When receiving acknowledgement packets, the client node 23 displays a message showing that the order has been successfully received via a client interface.

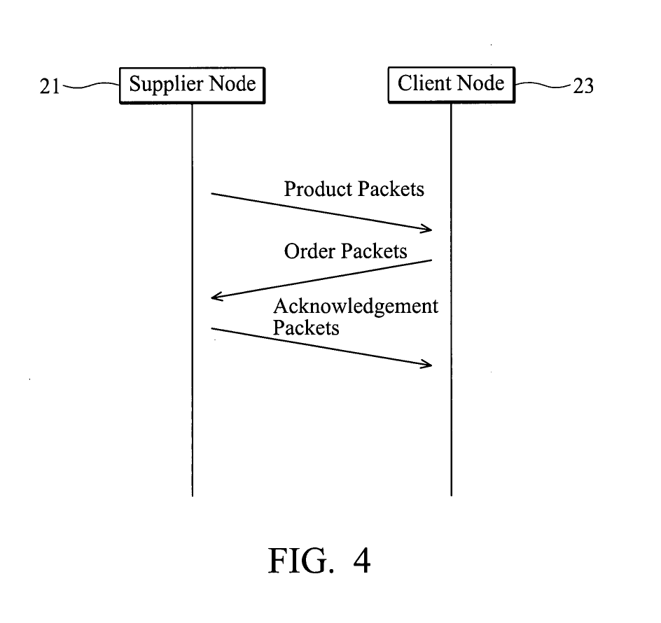

FIG. 4 is a message sequence diagram of a first embodiment for purchasing personalized electronic products. The supplier node 21 first transmits the described product packets to the client node 23. After receiving the product packets, the client node 23 transmits the described order packets to the supplier node 21. After receiving the order packets, the supplier node 21 transmits the described acknowledgement packets to the client node 23.

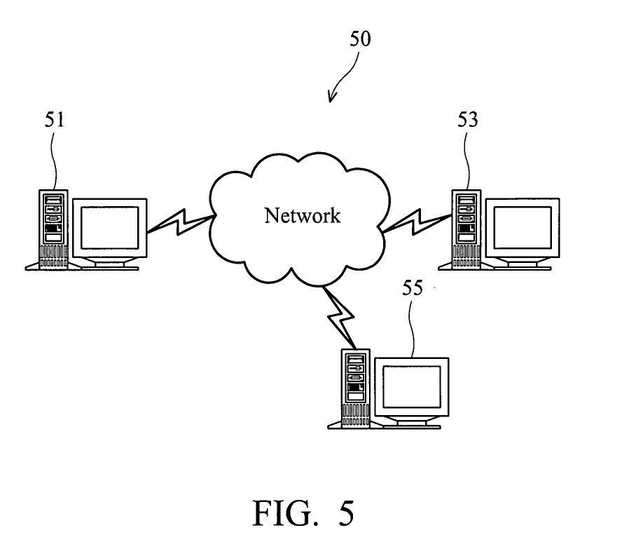

FIG. 5 is a diagram of the network architecture of a second embodiment of a system for purchasing personalized electronic products 50, preferably comprising personal computers 51, 53 and 55. The personal computers may be practiced in the hardware environment illustrated by FIG. 1. The personal computers 51, 53 and 55 may be connected for operating in a wired, wireless or mixed network. Those skilled in the art will recognize that the personal computers 51, 53 and 55 and with communication conducted via various types of transmission devices such as routers, gateways, access points, base station systems or others. The personal computer 51 represents a supplier node, the personal computer 53 represents a proxy node, and the personal computer 55 represents a client node.

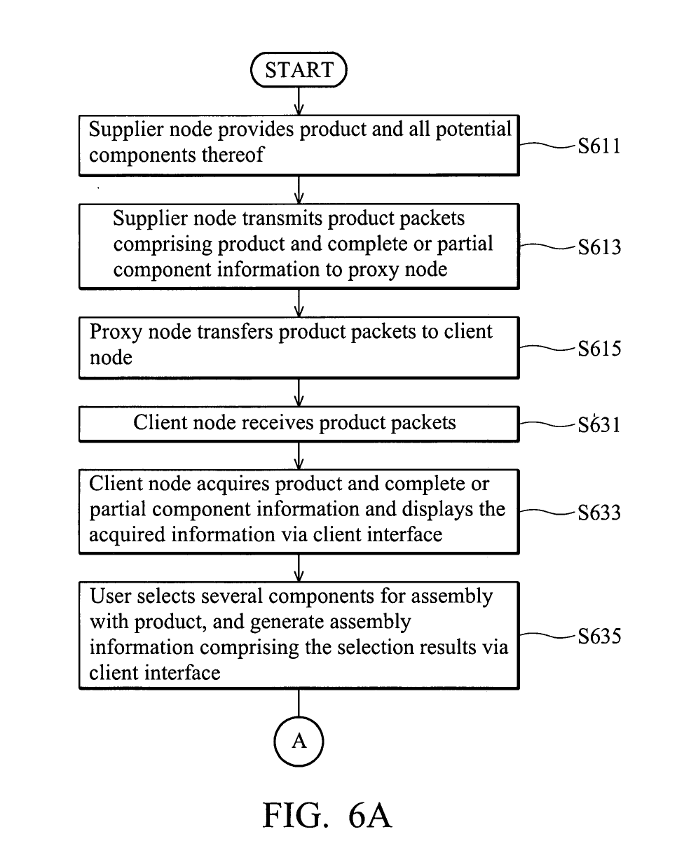

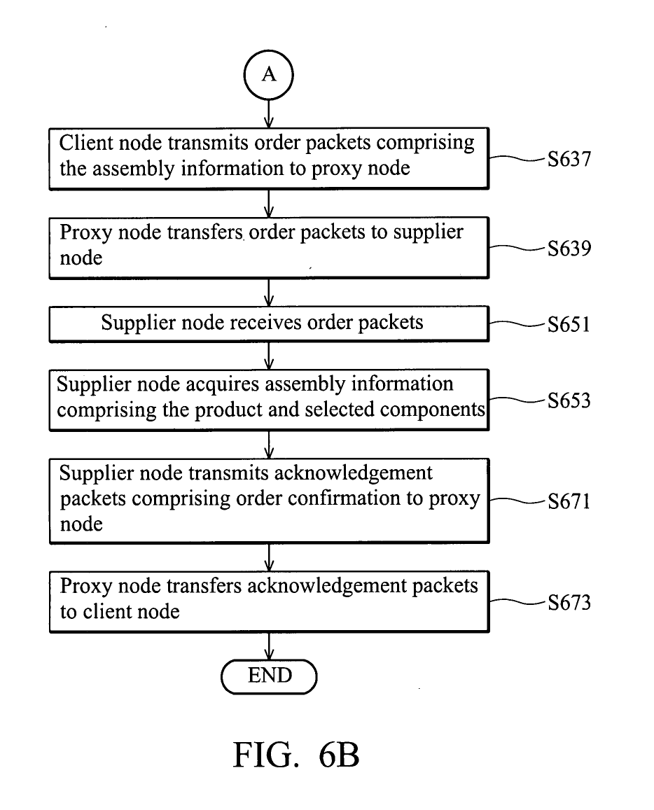

FIGS. 6A AND 6B are flowcharts illustrating a second embodiment of a method for purchasing personalized electronic products. In step S611, a product and all potential components thereof (including parts and accessories) are provided by the supplier node 51. In step S613, product packets comprising the product and complete or partial component information are transmitted to the proxy node 53 by the supplier node 51. In step S615, the received product packets are transferred to the client node 55 by the proxy node 53. In step S631, the product packets are received by the client node 55. In step S633, the product and complete or partial component information is acquired by the client node 55, and the acquired information is displayed via a client interface (e.g. a Web page). In step S635, components are selected for assembly with the product, and assembly information comprising user selections is generated via the client interface by the client node 55. In step S637, order packets comprising the assembly information are transmitted to the proxy node 53 by the client node 55. In step S639, the received order packets are transferred to the supplier node 51 by the proxy node 53. In step S651, the order packets are received by the supplier node 51. In step S653, the supplier node 51 acquires assembly information comprising the product and selected components. The supplier node 51 may comprise a supplier interface for displaying the product and the selected components, enabling the operators to deliver the product containing the selected components to the customer. In step S671, acknowledgement packets comprising order confirmation are transmitted to the proxy node 53 by the supplier node 51. In step S673, the received acknowledgement packets are transferred to the client node 55 by the proxy node 53. When receiving the acknowledgement packets, the client node 55 displays a message showing that the order has been successfully received via a client interface.

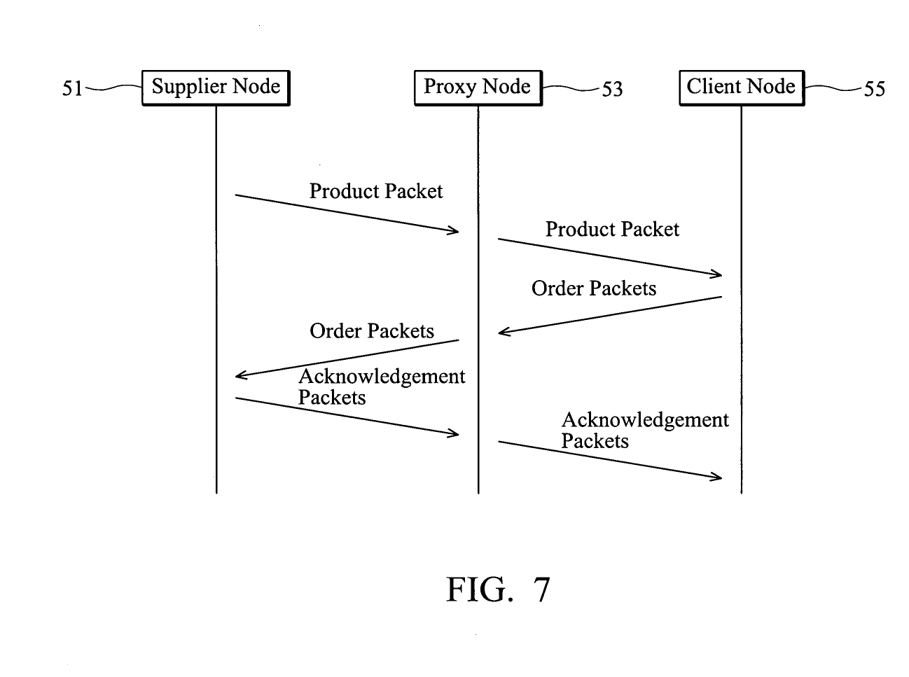

FIG. 7 is a message sequence diagram of a second embodiment for purchasing personalized electronic products. At the beginning, the supplier node 51 transmits the described product packets to proxy node 53, and then, the proxy node 53 transfers the product packets to the client node 55. After receiving the product packets, the client node 23 transmits the described order packets to the proxy node 53. The proxy node 53 then transfers the order packets to the supplier node 51. After receiving the order packets, the supplier node 51 transmits the described acknowledgement packets to the proxy node 53, and then, the proxy node 53 transfers the acknowledgement packets to the client node 55.

Although the invention has been described in terms of preferred embodiment, it is not limited thereto. Those skilled in this technology can make various alterations and modifications without departing from the scope and spirit of the invention. The invention is not limited to merely test or simulation applications. Any applications relating to cross-platform message exchanging should be covered by the scope of the invention. Therefore, the scope of the invention shall be defined and protected by the following claims and their equivalents.

What is claimed is:

1. A system for purchasing personalized products, comprising:
a client node; and
a supplier node,
wherein the supplier node provides a product packet comprising a product and a plurality of components belonging to the product, and transmits the product packet to the client node, the client node comprises a client interface displaying product packet information and means for selecting components belonging to the product for generating assembly information, and generates an order packet according to the user provided assembly information, and the supplier node receives the order packet from the client node.

2. The system as claimed in claim 1 wherein the product packet or the order packet containing all the components belonging to the product.

3. The system as claimed in claim 1 wherein the product packet or the order packet containing a portion of the components belonging to the product.

4. The system as claimed in claim 1 wherein the supplier node further comprises a supplier interface showing information of the order packet.

5. The system as claimed in claim 1 further comprising a proxy node between the supplier node and the client node.

6. The system as claimed in claim 1 wherein the supplier node generates an acknowledgement packet according to the order packet generated by the client node.

7. A method for purchasing personalized products, comprising:
generating a product packet by a supplier node according to a product and a plurality of components belonging to the product;
transmitting the product packet to a client node by the supplier node;
generating an order packet by the client node according to information indicating that a user has selected components belonging to the product;
transmitting the order packet to the supplier node by the client node; and
displaying the order packet information by the supplier node,
thereby enabling the manufacturer to deliver products to user according to the order packet information.

8. The method as claimed in claim 7 wherein the product packet or the order packet contains all the components belonging to the product.

9. The method as claimed in claim 1 wherein the product packet or the order packet containing a portion of the components belonging to the product.

10. The method as claimed in claim 7 further comprising transmitting an acknowledgement packet to the client node by the supplier node.

11. The method as claimed in claim 10 wherein the acknowledgement packet is transferred via a proxy node.

12. The method as claimed in claim 7 wherein the supplier node transmits the product packet to the client node via a proxy node.

13. The method as claimed in claim 7 wherein the client node transmits the order packet to the supplier node via a proxy node.
